(19) United States
(12) Patent Application Publication
(10) Pub. No.: US 2014/0015293 A1
(43) Pub. Date: Jan. 16, 2014

(54) SEAT, IN PARTICULAR VEHICLE SEAT, WITH MASSAGE FUNCTIONALITY

(71) Applicants: Wolfgang Pellenz, Meckenheim (DE); Robin Ndagijimana, Neuss (DE); Simon Fleischheuer, Langenfeld (DE); Harald Mund, Linnich (DE); Nils Frisse, Kohn (DE)

(72) Inventors: Wolfgang Pellenz, Meckenheim (DE); Robin Ndagijimana, Neuss (DE); Simon Fleischheuer, Langenfeld (DE); Harald Mund, Linnich (DE); Nils Frisse, Kohn (DE)

(73) Assignee: Johnson Controls GMBH, Burscheid (DE)

(21) Appl. No.: 14/008,155

(22) PCT Filed: Mar. 28, 2012
(86) PCT No.: PCT/EP12/55542

§ 371 Date: Sep. 27, 2013

(30) Foreign Application Priority Data
Mar. 28, 2011 (DE) 102011015319.5

(51) Int. Cl. B60N 2/44

(52) U.S. Cl. CPC B60N 2/448
USPC 297/217.3; 297/217.1

(57) ABSTRACT

A seat (1), in particular a vehicle seat, is provided with massage functionality. In a seat surface (2) and/or in a backrest (3) and/or in a headrest (4), there is arranged in each case at least one actuation device (5) which is in the form of an artificial muscle and which exerts a massaging action on a seat occupant during operation.

### CROSS REFERENCE TO RELATED APPLICATIONS

This application is a United States National Phase Application of International Application PCT/EP2012/055542 filed Mar. 28, 2012 and claims the benefit of priority under 35 U.S.C. §119 of German Patent Application DE 10 2011 015 319.5 filed Mar. 28, 2011, the entire contents of which are incorporated herein by reference.

### FIELD OF THE INVENTION

The invention relates to a seat, in particular vehicle seat, with massage functionality.

### BACKGROUND OF THE INVENTION

DE 10 2007 017 809 A1 discloses a seat arrangement which comprises an active material operatively connected to a seat surface, said material being configured in order to undergo an alteration of at least one property when an activation signal is received, wherein the alteration of at least one property serves to alter at least one feature of the seat surface.

DE 3713370 A1 discloses a vehicle seat which comprises a suitable massage device which is integrated in a region of the backrest part of the vehicle seat, against which a part of the human body to be massaged bears. The massage device comprises a motor arranged in a motor chamber and a spiral spring arranged in a spring chamber, the one end thereof being fastened to an inner surface of the spring chamber. The spiral spring comprises a winding portion which is wound in a multi-stepped shape. With a high-speed rotation for producing a high-speed vibration, said vibration is transmitted to the spiral spring in order to produce a resonance in the spring whereby the winding portion of the spring produces a high-speed vibration which is mutually amplified in a superimposed manner until it has an ultra-high speed. The ultra-high speed vibration thus produced is transmitted to the air in the spring chamber and produces an ultrasound-like vibration which is used for massaging the human body. The vehicle seat provided with the massage device fulfils the essential functions of a seat without the appearance of the seat being impaired and may perform a massage function on the vehicle driver or the like at any desired time.

### SUMMARY OF THE INVENTION

It is an object of the present invention to specify a seat, in particular a vehicle seat, with massage functionality which is improved relative to the prior art.

According to the invention, a seat, in particular the vehicle seat, is provided with massage functionality, with at least one actuation means arranged in each case in a seat surface and/or a backrest and/or a headrest. The actuation means is configured as an artificial muscle and exerting a massaging action on a seat occupant during operation.

As a result, a seat which is able to be produced cost-effectively with massage functionality is provided for the seat occupant in which, in particular, the number of mechanical components is significantly reduced.

In particular, by the use of artificial muscles arranged in the manner of fingers, massage movements which are similar to a manual massage may be performed.

In this case, the seat is configured substantially as a conventional seating device, for example as a chair, armchair or particularly preferably as a vehicle seat.

Preferably, the artificial muscle is formed from an electroactive polymer or comprises an electroactive polymer.

In an alternative embodiment, the artificial muscle is actuated pneumatically or hydraulically.

Advantageously, with corresponding actuation the shape or volume of an artificial muscle is altered without rotary or sliding guidance.

Particularly advantageously, by means of the artificial muscle or the artificial muscles, low-frequency vibrations may be produced on a seat surface facing the vehicle occupant. Expediently, a frequency of the vibrations produced by means of the artificial muscle may be adjusted in a variable manner. Thus, the frequency of the vibrations produced may be adjusted individually by the respective seat occupant.

In a preferred embodiment, by means of the artificial muscle or the artificial muscles, low-frequency deformations may be produced of the seat surface facing the vehicle occupant. Expediently, a degree of deformation of the deformations effected by means of the artificial muscle may be adjusted in a variable manner. Thus, the degree of deformation of the seat surface may be adjusted individually by the respective seat occupant.

In a first variant, each of the artificial muscles arranged in a seat may be actuated separately, so that by activating corresponding artificial muscles the seat occupant is able to permit individual regions or portions of his/her body to be massaged in a targeted manner.

In a second variant, the artificial muscles arranged in a seat may be actuated in groups. In this manner, for example, predetermined massage sequences may be performed by corresponding simultaneous or successive activation of corresponding artificial muscles. The invention is described in more detail with reference to the accompanying schematic figure. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a seat with a massage functionality effected by means of an actuation means.

### DESCRIPTION OF THE PREFERRED EMBODIMENTS

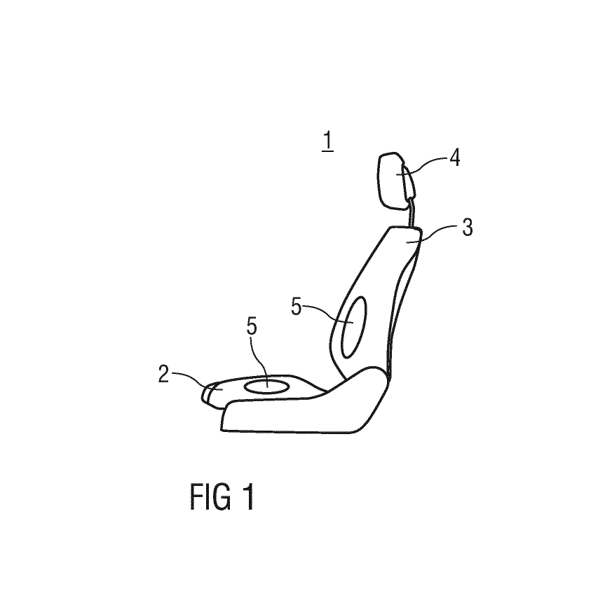

Referring to the drawings in particular, FIG. 1 shows schematically a seat 1 with a massage functionality effected by means of an actuation means 5.

In this case the seat 1 is configured substantially as a conventional seating device, for example as a chair, armchair or particularly preferably as a vehicle seat.

The seat 1 is, for example, a vehicle seat which comprises at least one seat surface (seat part or seat portion) 2, a seat backrest 3 and a headrest 4.

According to the invention, at least one actuation means 5 which is configured as an artificial muscle is arranged in each case in the seat surface 2 and/or the backrest 3 and/or the headrest 4 and exerts a massaging action on a seat occupant during operation.

An artificial muscle is a device in which the excitation thereof effects a shape alteration or volume alteration without a rotary or sliding guidance of components which are displaceable relative to one another necessarily being required (other than in an electromagnet).

As a result, a seat 1 with a massage functionality which is able to be produced cost-effectively is provided for the seat occupant, in which in particular the number of mechanical components is significantly reduced.

It is also provided in a particularly advantageous manner that the artificial muscle is used for producing preferably low-frequency vibrations or deformations of the seat surface, in particular for providing a massage function for the occupant of the vehicle seat.

In particular, by the use of artificial muscles arranged in the manner of fingers, massage movements are performed which are similar to a manual massage.

In these cases it is preferred that the artificial muscle is arranged in the backrest 3 of the vehicle seat and namely, in particular, in the spatial vicinity of the bearing surface for the seat occupants.

Preferably, said artificial muscle comprises an electroactive polymer (electroactive polymer artificial muscle (EPAM)), wherein the excitation takes place by applying an electrical current. A suitable device is provided, for example, by SRI Robots. EPAMs have high force, high deformation speed and rapid reaction behavior.

In an alternative embodiment, the artificial muscle is actuated pneumatically or hydraulically.

Advantageously, by corresponding actuation, the shape or volume of the artificial muscle is altered without rotary or sliding guidance.

Particularly advantageously, by means of the artificial muscle or the artificial muscles, low-frequency vibrations may be produced on a seat surface facing the vehicle occupant. Expediently, a frequency of the vibrations produced by means of the artificial muscle may be adjusted in a variable manner. Thus the frequency of the vibrations produced may be individually adjusted by the respective seat occupant.

In a preferred embodiment, by means of the artificial muscle or the artificial muscles, low-frequency deformations may be produced of the seat surface facing the vehicle occupant of the seat 1. Expediently, a degree of deformation of the deformations effected by the artificial muscle may be adjusted in a variable manner. Thus, the degree of deformation of the seat surface (surface of the seat portion, surface of the backrest, surface of the headrest) may be individually adjusted by the respective seat occupant.

In a first variant, each of the artificial muscles arranged in a seat 1 may be actuated separately, so that by activating corresponding artificial muscles the seat occupant is able to permit individual regions or portions of his/her body to be massaged in a targeted manner.

In a second variant, the artificial muscles arranged in a seat 1 are able to be actuated in groups. In this manner, for example, predetermined massage sequences are able to be performed by means of appropriate simultaneous or successive activation of corresponding artificial muscles.

While specific embodiments of the invention have been shown and described in detail to illustrate the application of the principles of the invention, it will be understood that the invention may be embodied otherwise without departing from such principles.

1. A seat with massage functionality, the seat comprising:
an actuation means for exerting a massaging action on a seat occupant during a vehicle operation, said actuating means being arranged at least one of in a seat surface in a backrest and in a headrest, said actuation means being configured as an artificial muscle and exerting the massaging action on the seat occupant during the operation.

2. The seat as claimed in claim 1, wherein the artificial muscle is formed from an electroactive polymer or comprises an electroactive polymer.

3. The seat as claimed in claim 1, wherein the artificial muscle is actuated pneumatically or hydraulically.

4. The seat as claimed in claim 1, wherein with corresponding actuation the shape or volume of an artificial muscle is altered without rotary or sliding guidance.

5. The seat as claimed in claim 1, wherein by means of the artificial muscle or the artificial muscles, low-frequency vibrations may be produced on a seat surface facing the vehicle occupant.

6. The seat as claimed in claim 5, wherein a frequency of the vibrations produced by means of the artificial muscle may be adjusted in a variable manner.

7. The seat as claimed in claim 1 wherein by means of the artificial muscle or the artificial muscles, low-frequency deformations of the seat surface are produced facing the vehicle occupant.

8. The seat as claimed in claim 7, wherein a degree of deformation of the deformations effected by means of the artificial muscle may be adjusted in a variable manner.

9. The seat as claimed in claim 1 wherein:
the actuation means comprises the artificial muscle and an additional artificial muscle to provide a plurality of artificial muscles; and
each of the artificial muscles arranged in the seat may be actuated separately.

10. The seat as claimed in claim 1, wherein:
the actuation means comprises the artificial muscle and additional artificial muscles to provide a plurality of artificial muscles; and
the artificial muscles arranged in the seat may be actuated in groups.

11. A vehicle seat comprising:
a seat part with a seat part surface;
a backrest with a backrest surface; and
an artificial muscle disposed in one of the seat part and the backrest and generating massaging action vibrations at one of the associated seat part surface and backrest surface, the artificial muscle exhibiting a shape alteration or a volume alteration upon excitation thereof, without a rotary or sliding guidance of components which are displaceable relative to one another.

12. The vehicle seat as claimed in claim 11, wherein the artificial muscle comprises an electroactive polymer exhibiting the shape alteration or the volume alteration upon excitation via the application of an electrical current.

13. The vehicle seat as claimed in claim 11, wherein the artificial muscle includes an enclosure with gas or fluid and exhibits the shape alteration or the volume alteration upon excitation via pneumatic or hydraulic pressure variation.

14. A vehicle seat comprising:
a seat part with a seat part surface;
a backrest with a backrest surface; and
an artificial muscle disposed in one of the seat part and the backrest and generating massaging action vibrations at one of the associated seat part surface and backrest surface, the artificial muscle comprising an electroactive polymer artificial muscle.
